(19) United States
(12) Patent Application Publication
(10) Pub. No.: US 2005/0271244 A1
(43) Pub. Date: Dec. 8, 2005

(54) Resin frame, resin grille and speaker device

(76) Inventors: Hiroyuki Kobayashi, Yamagata (JP); Kenichi Kasahara, Yamagata (JP); Shinichi Hayasaka, Yamagata (JP); Toshihiro Hikichi, Yamagata (JP)

Correspondence Address: YOUNG & THOMPSON, 745 SOUTH 23RD STREET, 2ND FLOOR, ARLINGTON, VA, 22202, US

(21) Appl. No.: 11/085,163

(22) Filed: Mar. 22, 2005

(30) Foreign Application Priority Data
Mar. 25, 2004 (JP) 2004-89294

(51) Int. Cl. H04R 1/00; H04R 9/06; H04R 11/02

(52) U.S. Cl. 381/433; 381/396

(57) ABSTRACT

A speaker device includes a resin frame and a resin grille mounted thereto. In the resin frame and the resin grille, engaging claws that engage with each other are formed, respectively. An inclined surface is formed on at least one of the engaging claws of the resin frame and the resin grille, and the other engaging claw engages with the one engaging claw on the inclined surface. When environmental temperature falls, the resin frame and the resin grille contract in the vertical and horizontal directions, and, when the temperature rises, the resin frame and the resin grille expand in the vertical and horizontal directions. However, even when such temperature changes occur, the engaging claw of the resin frame constantly engages with the inclined surface of the resin grille. Therefore, no backlash occurs between the engaging claw of the resin frame and the engaging claw of the resin grille.

### TECHNICAL FIELD

The present invention relates to a mounting structure of a resin frame and a resin grille in a speaker device.

### BACKGROUND ART

Conventionally, there is known a speaker device having a resin frame for supporting a magnetic circuit, a diaphragm, etc. and a resin grille provided so as to cover the front surface side of the diaphragm for the purpose of protecting the diaphragm. In such a speaker device, the diaphragm is protected by attaching the resin grill to the resin frame.

Especially, in such a speaker device, in order to promptly perform repair work in the case of failure or the like, a mounting structure is adopted in which the resin grille and the resin frame are easily attached and detached is adopted. For example, a structure in which engaging claws that engages with each other are provided to outer peripheral edges of the resin grille and the resin frame, respectively, and the engaging claws are caught in each other and fastened. As a mounting structure of this kind, for example, there is known a mounting structure in which a flat surface of the engaging claw of the resin frame and a flat surface of the engaging claw of the resin grille are joined and thereby those engaging claws are engaged with each other.

However, in the above speaker device, since the resin frame and the resin grille of resin materials are used, there is a problem that the resin frame and the resin grille expand/contract due to environmental changes such as temperature change, and the engagement condition of those engaging claws becomes defective, and backlash occurs in the engaging claws.

Incidentally, there is known a speaker device in which a frame and a grille member are fastened to a cabinet by screwing a fastening screw in a fastening hole of the grille member via a mounting hole of the frame (for example, see Japanese Patent Application Laid-Open under No. 2003-289592). Further, there is known a mounting structure of a speaker device by which a speaker frame is held by a vehicle door trims using relative rotation of the speaker frame and the vehicle door trim (for example, see Japanese Patent Application Laid-Open under No. 2002-335593).

### DISCLOSURE OF THE INVENTION

As a problem to be solved by the invention, the above problem can be cited as an example. An object of the invention is to provide a speaker device having a mounting structure of a resin frame and a resin grille in which no backlash occurs due to environmental changes such as temperature change.

In one embodiment of the invention, a resin frame for a speaker device has an engaging claw that engages with an engaging claw of a resin grille, and an inclined surface is formed on the engaging claw of the resin frame at a side facing the resin grille.

According to the above resin frame, the resin grille is mounted to the resin frame by engaging the inclined surface of the resin frame with the engaging claw of the resin grille. In this structure, even when the resin grille and the resin frame expand/contract due to temperature changes, the engaging claw of the resin grille constantly and stably engages with a part of the inclined surface of the resin frame. Therefore, no backlash occurs between the engaging claw of the resin grille and the engaging claw of the resin frame. Thus, the resin frame can be stably engaged with the resin grille independently from the environment changes such as temperature change.

Further, it is preferable that the engaging claw of the resin frame including the inclined surface is formed simultaneously with the molding of the main body of the resin frame, and thereby, the production cost of the resin frame can be prevented from increasing.

In another embodiment of the invention, a resin grille for a speaker device has an engaging claw that engages with an engaging claw of a resin frame, and an inclined surface is formed on the engaging claw of the resin grille at a side facing the resin frame.

According to the resin grille, the resin grille is mounted to the resin frame by engaging the inclined surface of the resin grille and the engaging claw of the resin frame. In this structure, even when the resin grille and the resin frame expand/contract due to temperature changes, the engaging claw of the resin frame constantly and stably engages with a part of the inclined surface of the resin grille. Therefore, no backlash occurs between the engaging claw of the resin grille and the engaging claw of the resin frame. Thus, the resin frame can be stably engaged with the resin grille independently from the environment changes such as temperature change.

Further, it is preferable that the engaging claw of the resin grille including the inclined surface is formed simultaneously with the molding of the main body of the resin grille, and thereby, the production cost of the resin grille can be prevented from increasing.

Further, in a preferred example, a rib for fastening the engaging claw may be formed at a side facing an upper surface of the engaging claw of the resin frame. Thereby, even when the resin grille and the resin frame expand/contract, the engaging claw of the resin frame can be stably fastened.

In another embodiment of the invention, in a speaker device including a resin grille and a resin frame in each of which an engaging claw is formed and formed by mounting the resin grille to the resin frame by engaging the respective engaging claws, an inclined surface is formed in at least one of the respective engaging claws.

According to the above speaker device, the resin grille is mounted to the resin frame by engaging the engaging claw of the resin grille and the engaging claw of the resin frame. An inclined surface is formed on at least one of the respective engaging claws of the resin frame and the resin grille.

Accordingly, in the case where an inclined surface is formed in each of the engaging claw of the resin frame and the resin grille, the inclined surface of the resin frame and the inclined surface of the resin grille abut and engage with each other. On the other hand, in the case where an inclined surface is formed on the engaging claw of at least one of the resin grille and the resin frame, the engaging claw of the other abuts and engages with a part of the inclined surface of the engaging claw of the one of the resin grille and the resin frame.

In this structure, even when the resin grille and the resin frame expand/contract due to temperature changes, since the inclined surfaces of the resin grille and the resin frame, or the inclined surface of one of the resin grille and the resin frame and the engaging claw of the other are constantly and stably engaged, no backlash occurs between the engaging claw of the resin grille and the engaging claw of the resin frame. Thus, the resin frame can be stably mounted to the resin grille independently from the environment changes such as temperature change.

Further, in a preferred example, the engaging claw in which no inclined surface is provided may have a hook-like shape. Further, the engaging claw may be formed on an outer peripheral edge of the resin frame and an outer peripheral edge of the resin grille.

Further, in a preferred example, the resin grill in which a rib for fastening the engaging claw is formed at a side facing an upper surface of the engaging claw of the resin frame is applied to the speaker device. Thereby, even when the resin grille and the resin frame expand/contract, the engaging claw of the resin frame can be stably fastened.

### BRIEF DESCRIPTION OF THE DRAWINGS

FIG. 1A shows a configuration of a speaker device of the invention as a sectional view, and FIG. 1B shows it as a rear view thereof.

FIGS. 2A to 2C show a mounting structure of a resin grille and a resin frame according to the first embodiment as sectional views.

FIGS. 3A to 3C show a mounting structure of a resin grille and a resin frame according to the second embodiment as sectional views.

FIGS. 4A to 4C show a mounting structure of a resin grille and a resin frame according to the third embodiment as sectional views.

FIGS. 5A to 5C show a mounting structure of a resin grille and a resin frame according to the fourth embodiment as sectional views.

### BEST MODE FOR CARRYING OUT THE INVENTION

Hereinafter, preferred embodiments of the invention will be described by referring to the drawings. The embodiments provide a speaker device having a mounting structure of a resin frame and a resin grille in which no backlash occurs due to environmental changes such as temperature change.

[Configuration of Speaker Device]

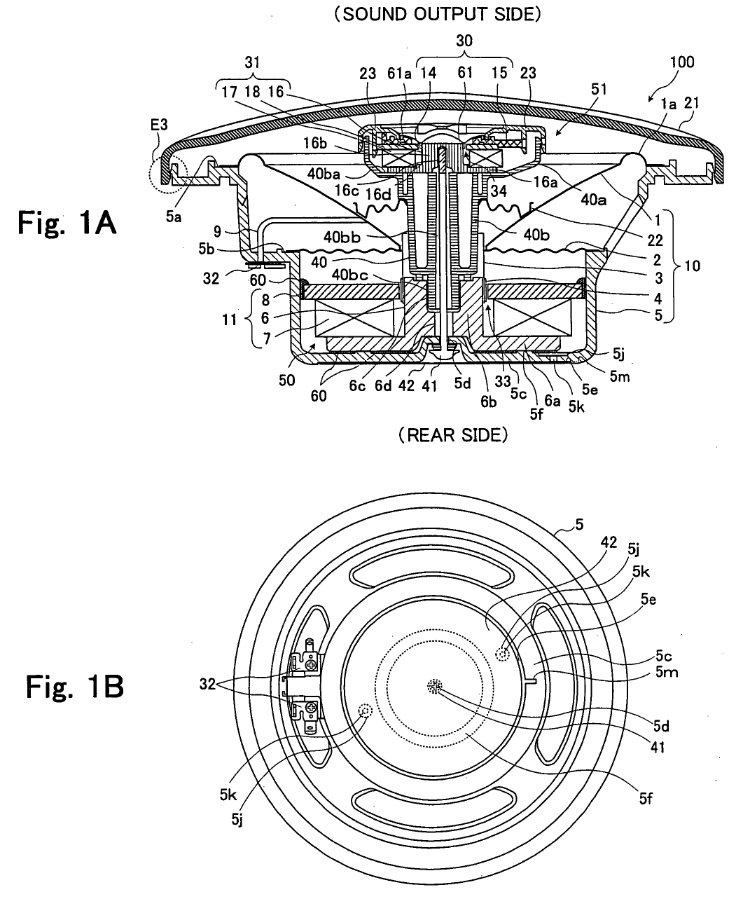

First, in FIGS. 1A and 1B, an outline configuration of a speaker device 100 according to the embodiments of the present invention is schematically shown. FIG. 1A is a sectional view when the speaker device 100 is cut along a plane containing a central axis thereof. FIG. 1B is a rear view of the speaker device 100. The speaker device 100 in the embodiments can be used preferably as a marine speaker. As below, referring to FIGS. 1A and 1B, the configuration etc. of the speaker device 100 of the embodiments will be described.

The speaker device 100 includes a speaker unit 50 for low-frequency band reproduction, a speaker unit 51 for high-frequency band reproduction, and other various kinds of members. The speaker device 100 is a so-called coaxial type two-way speaker, and is configured by coaxially disposing the speaker unit 51 for high-frequency band reproduction at the sound output side and the speaker unit 50 for low-frequency band reproduction at the rear side. Accordingly, the speaker device 100 can realize flat sound reproduction from the low-frequency band to the high-frequency band. Incidentally, the speaker unit 50 for low-frequency band reproduction may be a speaker unit capable of low and middle frequency band reproduction. Further, the speaker unit 51 for high-frequency band reproduction may be a speaker unit capable of high and middle frequency band reproduction.

First, a configuration of the speaker unit 50 for low-frequency band reproduction will be described. The speaker unit 50 for low-frequency band reproduction mainly includes a vibration system 10 having a diaphragm 1, a damper 2, a waterproof damper 22, a voice coil bobbin 3, a voice coil 4 and a resin frame 5, a magnetic circuit system 11 having a pole piece 6, an annular magnet 7 and an annular plate 8, and a resin grille 21.

First, the respective constitutive elements of the vibration system 10 will be described.

The diaphragm 1 is a so-called conical diaphragm, and a separate edge portion 1a is bonded thereto or the diaphragm 1 is formed integrally with the edge portion 1a. Various kinds of materials such as paper, polymer or metal can be applied to the diaphragm 1 according to various kinds of application. The outer peripheral edge of the diaphragm 1, namely, the lower end part of the edge portion 1a is fixed onto a first flange portion 5a located at the upper part of the resin frame 5. On the other hand, the inner peripheral edge of the diaphragm 1 is fixed onto the vicinity of the upper end of the outer circumferential wall of the voice coil bobbin 3.

The damper 2 is made of a material of cloth impregnated with a thermosetting resin such as phenol resin or the like, and plural corrugations are concentrically formed. The damper 2 movably supports the voice coil bobbin 3. The inner peripheral edge of the damper 2 is fixed to the outer circumferential wall of the voice coil bobbin 3. On the other hand, the outer peripheral edge of the damper 2 is fixed onto a second flange portion 5b formed in the vicinity of the central part of the resin frame 5.

The waterproof damper 22 fulfills a function of preventing water droplets etc. from entering from the sound output side into the magnetic circuit system 11 etc. For the purpose, as a material for the waterproof damper 22, for example, a material such as thermoplastic elastomer is appropriate. The outer peripheral edge of the waterproof damper 22 is mounted in a predetermined position of the diaphragm 1, and the inner peripheral edge of the waterproof damper 22 is mounted to the outer circumferential wall of a connecting portion 40b of a supporting member 40, which will be described later.

The voice coil bobbin 3 has a substantially cylindrical shape. The voice coil 4 is wound around the outer circumferential wall of the lower end part of the voice coil bobbin 3. Further, the outer circumferential wall of the lower end part of the voice coil bobbin 3 faces the inner circumferential wall of the annular plate 8 with a certain space therebetween. Furthermore, the inner circumferential wall of the lower end part of the voice coil bobbin 3 faces the outer circumferential wall of the upper end part of the pole piece 6 with a certain space therebetween. Thus, a gap (magnetic gap 33) is formed between the outer circumferential wall of the upper end part of the pole piece 6 and the inner circumferential wall of the plate 8.

The voice coil 4 has positive/negative lead terminals (not shown). The positive side lead terminal is an input terminal of L (or R) channel signal, and the negative side lead terminal is an input terminal of ground (GND: earth) signal. The respective lead terminals are electrically connected to the ends of respective tinsel wires 9 in the predetermined position of the diaphragm 1 and the other ends of the respective tinsel wires 9 are electrically connected to a connection terminal 32. To the voice coil 4, electric signals for one channel are input from an amplifier (not shown) side via the connection terminal 32 and the tinsel wires 9.

The resin frame 5 is a frame made of a resin material. Onto the resin frame 5, various components of the speaker device 100 are fixed, and the resin frame 5 serves to support the speaker device 100. The resin frame 5 has a shape of a pan or pot opening upwardly, and has the first flange portion 5a that supports the edge portion 1a of the diaphragm 1, the second flange portion Sb that supports the outer peripheral edge of the damper 2, and a mounting portion 5c on which the magnetic circuit system 11 is placed. Incidentally, an engaging claw 5g or 5h is formed on the outer peripheral edge of the resin frame 5, however, a function etc. thereof will be described later.

The first flange portion 5a is formed in a position of the upper part of the resin frame 5, and the second flange portion 5b is formed in a position of the central part of the resin frame 5. The mounting portion 5c is formed in a position at the lower part side of the resin frame 5, namely, at the rear side thereof. A recess having a truncated cone shape is formed in the vicinity of the central axis of the mounting portion 5c from the lower surface side to the upper surface side thereof. The mounting portion 5c has an opening 5d on the central axis thereof, a step portion 5j and a hole portion 5k in the vicinity of the peripheral edge thereof, and a recess (concave) portion 5e and a slit 5m at the rear side thereof. The step portion 5j, the hole portion 5k, the recess portion 5e and the slit 5m serve to prevent production of air bubbles of an adhesive agent 60 due to volume change of space between the magnetic circuit system 11 and the resin frame 5 at the time of assembly of the speaker unit 50 for low-frequency band reproduction. A fastening member 41, which will be described later, penetrates the opening 5d, and a nameplate 42, which will be described later, is attached to the recess portion 5e. The name plate 42 is used for application of improvement of the appearance of the rear side of the speaker 100 or recognition of product information etc. for users.

Next, the respective constitutive elements of the magnetic circuit system 11 will be described.

The magnetic circuit system 11 is formed as an external magnet type magnetic circuit. This magnetic circuit has the pole piece 6, the annular magnet 7 and the annular plate 8.

The pole piece 6 has an inverted T section. The pole piece 6 is fixed onto the mounting portion 5c of the resin frame 5 via the adhesive agent 60. The pole piece 6 has a flange-like yoke 6a, a center pole 6b having a cylindrical shape, and openings 6c and 6d provided within the center pole 6b.

The yoke 6a is located on the mounting portion 5c of the resin frame 5. A recess having a truncated cone shape is formed in the vicinity of the central axis of the lower surface side of the center pole 6b. The openings 6c and 6d formed within the center pole 6b are respectively different in diameter, and the openings communicate with each other. The opening 6c has a diameter slightly larger than that of the opening 6d, and is formed from the vicinity of the central part of the center pole 6b to the upper part thereof. On the other hand, the opening 6d is formed at the lower end side of the opening 6c, namely, from the central part side of the center pole 6b to the lower part thereof. Further, a lower end portion 40bc of the supporting member 40, which will be described later, is inserted into the opening 6c and the supporting member 40 is fastened to the center pole 6b. Furthermore, the fastening member 41 penetrates the openings 6c and 6d. Note that the fastening member 41 penetrates the opening 6c via a thorough hole 40bb of the supporting member 40, which will be described later.

The annular magnet 7 is disposed so as to be overlapped with the upper surface of the yoke 6a, and the annular plate 8 is disposed so as to be overlapped with the upper surface of the annular magnet 7. The center pole 6b upwardly extends within the openings of the central parts of the annular magnet 7 and the annular plate 8. The outer peripheral edge of the plate 8 is fixed for reinforcement to the inner circumferential wall of the resin frame 5 via the adhesive agent 60.

In the magnetic circuit system 11, a magnetic circuit is formed by the magnet 7, the plate 8 and the pole piece 6, and the magnetic flux of the magnet 7 is concentrated in the magnetic gap 33 formed between the inner circumferential wall of the plate 8 and the outer circumferential wall of the pole piece 6.

The resin grille 21 is made of a resin material, for example, and has a function of protecting the speaker unit 50 for low-frequency band reproduction and the speaker unit 51 for high-frequency band reproduction, or the like. For this purpose, the resin grille 21 is mounted on the resin frame 5 so as to cover the speaker units. Further, striped spacings (not shown) are formed intermittently at the upper surface side of the resin grille 21 so that the speaker unit 50 for low-frequency band reproduction and the speaker unit 51 for high-frequency band reproduction can emit sound waves through the spacings to the sound output side. Incidentally, an engaging claw 21a or 21c is formed on the outer peripheral edge of the resin grille 21, however, a function etc. thereof will be described later.

Next, the speaker unit 51 for high-frequency band reproduction will be described. The speaker unit 51 for high-frequency band reproduction mainly includes a vibration system 30 having a diaphragm 61, a voice coil 14 and an upper frame 15, and a magnetic circuit system 31 having a pole piece 16, an annular magnet 17 and an annular plate 18, and a cover 23.

First, the respective constitutive elements of the vibration system 30 will be described.

The diaphragm 61 is a so-called domical diaphragm, and is formed integrally with an edge portion 61a. Various kinds of materials such as paper, polymer, or metal can be applied to the diaphragm 61 according to various kinds of application as well as the above diaphragm 1. The outer peripheral edge of the diaphragm 61, namely, the lower end part of outer peripheral edge of the edge portion 61a is fixed onto the upper surface of the resin frame 15.

The voice coil 14 has a substantially cylindrical shape. The outer circumferential wall of the voice coil 14 faces the inner circumferential wall of the annular plate 18 with a certain space therebetween. On the other hand, the inner circumferential wall of the voice coil 14 faces the outer circumferential wall of the upper end part of the pole piece 16 with a certain space therebetween. Thus, a gap (magnetic gap 34) is formed between the outer circumferential wall of the pole piece 16 and the inner circumferential wall of the plate 18.

Further, the voice coil 14 has positive/negative lead terminals (not shown). The positive side lead terminal is an input terminal of L (or R) channel signal, and the negative side lead terminal is an input terminal of ground (GND: earth) signal. The respective lead terminals are electrically connected to the ends of respective tinsel wires (not shown) and the other ends of the respective tinsel wires (not shown) are electrically connected to a connection terminal (not shown). To the voice coil 14, electric signals for one channel are input from an amplifier (not shown) side via the connection terminal and the tinsel wires.

The upper frame 15 is made of a resin material and has a substantially annular form. The upper frame 15 is disposed so as to be overlapped with the upper surface of the annular plate 18. The upper frame 15 supports the outer peripheral edge of the diaphragm 61, namely, the edge 61a.

Next, the respective constitutive elements of the magnetic circuit system 31 will be described.

The magnetic circuit system 31 is formed as an external magnet type magnetic circuit system. The magnetic circuit has the pole piece 16, the annular magnet 17 and the annular plate 18.

The pole piece 16 has an inverted T section. Flatness is ensured in the lower surface of the pole piece 16. The pole piece 16 is fixed onto an upper end surface 40ba of the supporting member 40 via the adhesive agent 60 (not shown). The pole piece 16 has a flange-like yoke 16a, a center pole 16b having a cylindrical shape, a fastening hole 16c provided within the center pole 16b, and a step portion 16d formed between the outer peripheral edge of the lower end part of the center pole 16b and the yoke 16a and having a step-like section.

The yoke 16a is located on the upper end surface 40ba of the supporting member 40. A recess having a truncated cone shape is formed in the vicinity of the central axis of the lower surface side of the center pole 16b. The fastening hole 16c has a female thread, for example, and the leading end (for example, male thread) of the fastening member 41 is inserted and screwed. The outer circumferential wall of the step portion 16d is in contact with the outer circumferential wall of the lower end part of the magnet 17.

The annular magnet 17 is disposed so as to be overlapped with the upper surface of the yoke 16a. The inner circumferential wall of the lower end part of the annular magnet 17 is disposed at the outer circumferential side of the step portion 16d of the pole piece 16 as described above, and the annular magnet 17 is precisely positioned in a predetermined position on the yoke 16a. The annular plate 18 is disposed so as to be overlapped with the upper surface of the annular magnet 17.

In the magnetic circuit system 31, a magnetic circuit is formed by the magnet 17, the plate 18 and the pole piece 16, and the magnetic flux of the magnet 17 is concentrated in the magnetic gap 34 formed between the inner circumferential wall of the plate 18 and the outer circumferential wall of the pole piece 16.

The cover 23 is made of a resin material, for example, and mounted on a frame portion 40a of the supporting member 40, which will be described later, for covering the sound output side of the speaker unit 51 for high-frequency band reproduction. The cover 23 has a function of protecting the speaker unit 51 for high-frequency band reproduction, or the like.

As other various members of the speaker device 100, the supporting member 40, the fastening member 41 and the nameplate 42 are included.

The supporting member 40 has the connecting portion 40b having a cylindrical shape and the frame portion 40a extending from the upper end surface 40ba of the connecting portion 40b upwardly so as to cover the periphery of the speaker unit 51 for high-frequency band reproduction. The cover 23 is mounted on the frame portion 40a and covers the speaker unit 51 for high-frequency band reproduction. The connecting portion 40b coaxially arranges the speaker unit 50 for low-frequency band reproduction and the speaker unit 51 for high-frequency band reproduction. The lower end part 40bc of the connecting portion 40b is inserted into the opening 6c of the pole piece 6 and fastened as described above. The speaker unit 51 for high-frequency band reproduction is fixed to the upper end surface 40ba having flatness via the adhesive agent 60 (not shown). The through hole 40bb is formed within the connecting portion 40b so that it penetrates on the central axis thereof in a vertical direction, and the fastening member 41 penetrates the through hole 40bb.

As the fastening member 41, for example, a member such as a male screw or bolt is appropriate. At the leading end of the fastening member 41, a male thread corresponding to the female thread of the fastening hole 16c is formed. The fastening member 41 is inserted into the fastening hole 16c from the rear side of the speaker device 100 through the openings 5d, 6d and 6c and the through hole 40bb. Thereby, the speaker unit 50 for low-frequency band reproduction and the speaker unit 51 for high-frequency band reproduction are coaxially fixed via the supporting member 40.

The nameplate 42 is made of a polymer material or metal material and has a disc shape. The nameplate 42 is attached to the recess portion 5e of the resin frame 5 with a sticking agent or adhesive agent as described above. The product information, company name, etc. are printed on the nameplate 42.

In the above described speaker device 100, when electric signals are input to the respective tinsel wires from the amplifier side, the electric signals are supplied to the voice coils 4 and 14 via the respective lead terminals of the voice coils 4 and 14. Thereby, driving forces are generated in the voice coils 4 and 14 within the magnetic gaps 33 and 34, respectively, and the diaphragms 1 and 61 are vibrated in the axis direction of the speaker device 100. Thus, the speaker device 100 emits sound waves to the sound output side.

[Mounting Structure of Resin Frame and Resin Grille]

### First Embodiment

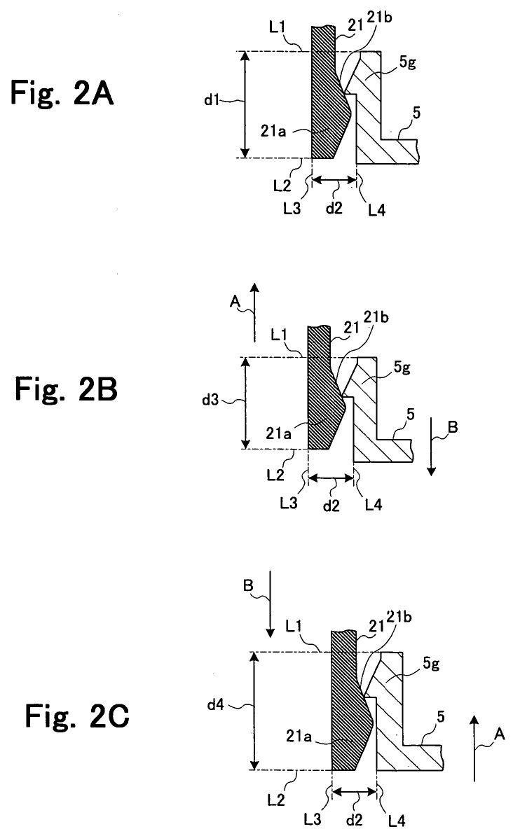

Next, referring to FIGS. 2A to 2C, a mounting structure of the resin frame 5 and the resin grille 21 according to the first embodiment of the invention will be described. FIG. 2A is a sectional view in which the part of the area E3 (within the area surrounded by a broken line) in FIG. 1A is enlarged. FIG. 2B is a sectional view in a state in which the resin grille 21 and the resin frame 5 contract due to temperature change. FIG. 2C is a sectional view in a state in which the resin grille 21 and the resin frame 5 expand due to temperature change. For the purpose, the resin grille 21 and the resin frame 5 shown in FIG. 2A to 2C are slightly different in dimensions, respectively.

In the speaker device 100, the resin grille 21 is mounted to the resin frame 5 as shown in FIG. 2A. At the inside of the outer peripheral edge of the resin grille 21, the engaging claw 21a projecting toward the central direction is formed in the circumferential direction, and an inclined surface 21b is formed in the engaging claw 21a. On the other hand, at the outside of the outer peripheral edge of the resin frame 5, the hook-like engaging claw 5g that engages with the engaging claw 21a of the resin grille 21 is formed in the circumferential direction. The inclined surface 21b of the resin grille 21 engages with the engaging claw 5g of the resin frame 5 by the elastic force thereof. That is, the engaging claw 21a of the resin grille 21 and the engaging claw 5g of the resin frame 5 are caught in each other and fastened. At this time, the distance in the vertical direction between the line L1 passing through the upper end surface of the resin frame 5 and the line L2 passing through the lower end surface of the resin grille 21 is d1. On the other hand, the distance in the horizontal direction between the line L3 passing through the outer circumferential wall of the resin grille 21 and the line L4 passing through the outer circumferential wall of the resin frame 5 is d2.

When the temperature significantly falls from the state, the resin grille 21 and the resin frame 5 contract in the vertical and horizontal directions. Simultaneously, the vicinities of the engaging claw 21a of the resin grille 21 and the engaging claw 5g of the resin frame 5 contract as below. That is, as shown in FIG. 2B, the vicinity of the engaging claw 21a of the resin grille 21 contracts in the direction of an upward arrow A, and the vicinity of the engaging claw 5g of the resin frame 5 contracts in the direction of a downward arrow B. Further, the vicinities of the engaging claw 21a of the resin grille 21 and the engaging claw 5g of the resin frame 5 also contract in the radial direction (the horizontal direction in the drawing) of the speaker device 100. Accordingly, while the inclined surface 21b and the engaging claw 5g slidingly move relatively, the contact position between the engaging claw 5g of the resin frame 5 and the engaging claw 21a of the resin grille 21 moves downwardly.

At this time, the distance in the vertical direction between the line L2 passing through the lower end surface of the resin grille 21 and the line L1 passing through the upper end surface of the resin frame 5 changes to d3 (<d1). On the other hand, the distance in the horizontal direction between the line L3 passing through the outer circumferential wall of the resin grille 21 and the line L4 passing through the outer circumferential wall of the resin frame 5 is substantially d2 with little change. In other words, although the resin grille 21 and the resin frame 5 contract in the horizontal direction, respectively, the distance between the outer circumferential wall of the resin grille 21 and the outer circumferential wall of the resin frame 5 hardly changes from the state in FIG. 2A. This is because the contact position between the engaging claw 5g and the inclined surface 21b moves on the inclined surface 21b by the amounts in which the resin grille 21 and the resin frame 5 contract in the horizontal direction, respectively.

Further, when the temperature significantly rises from the state in FIG. 2A, the resin grille 21 and the resin frame 5 expand in the vertical and horizontal directions. Simultaneously, the vicinities of the engaging claw 21a of the resin grille 21 and the engaging claw 5g of the resin frame 5 expand as below. That is, as shown in FIG. 2C, the vicinity of the engaging claw 21a of the resin grille 21 expands in the direction of the downward arrow B, and the vicinity of the engaging claw 5g of the resin frame 5 expands in the direction of the upward arrow A. Further, the vicinities of the engaging claw 21a of the resin grille 21 and the engaging claw 5g of the resin frame 5 also expand in the radial direction of the speaker device 100. Accordingly, while the inclined surface 21b and the engaging claw 5g slidingly move relatively, the contact position between the engaging claw 5g of the resin frame 5 and the engaging claw 21a of the resin grille 21 moves upwardly.

At this time, the distance in the vertical direction between the line L2 passing through the lower end surface of the resin grille 21 and the line L1 passing through the upper end surface of the resin frame 5 changes to d4 (>d1). On the other hand, the distance in the horizontal direction between the line L3 passing through the outer circumferential wall of the resin grille 21 and the line L4 passing through the outer circumferential wall of the resin frame 5 is substantially d2 with little change. This is because the contact position between the engaging claw 5g and the inclined surface 21b moves on the inclined surface 21b by the amounts in which the resin grille 21 and the resin frame 5 expand in the horizontal direction, respectively.

As described above, according to the mounting structure of the resin grille 21 and the resin frame 5 according to the first embodiment, even when the resin grille 21 and the resin frame expand/contract due to temperature changes, the inclined surface 21b of the resin grille 21 and the engaging claw 5g of the resin frame 5 are engaged constantly in an abutting condition. That is, the contact position between the inclined surface 21b of the resin grille 21 and the engaging claw 5g of the resin frame 5 only moves along the inclined surface 21b by the amounts of construction/expansion, and no backlash occurs between the engaging claw 21a of the resin grille 21 and the engaging claw 5g of the resin frame 5 and both of them never depart. Therefore, in the case where the speaker device 100 is mounted on a ship, even if the vibration from the water surface is transmitted to the engaging claw 21a of the resin frame 5 and the engaging claw 5g of the resin grille 21, no abnormal noise is generated. Thus, the resin frame 5 can be stably mounted on the resin grille 21 independently from the environment changes such as temperature change.

### Second Embodiment

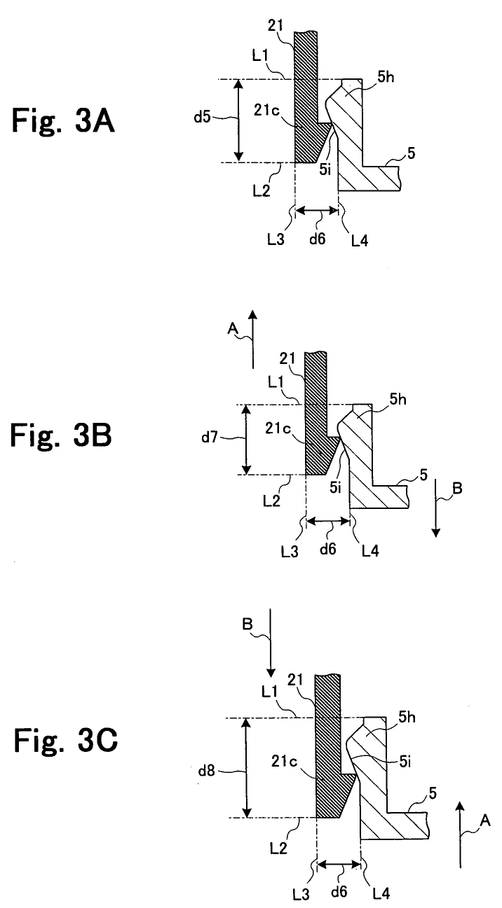

Next, referring to FIGS. 3A to 3C, a mounting structure of the resin frame 5 and the resin grille 21 according to the second embodiment will be described. In the above first embodiment, the inclined surface 21b is provided at the engaging claw 21a side of the resin grille 21, however, in the second embodiment, an inclined surface is provided in the engaging claw at the resin frame 5 side. Thereby, the same effect as in the above first embodiment is obtained.

FIG. 3A is a sectional view corresponding to the part of the area E3 in FIG. 1A. FIG. 3B shows a state in which the resin grille 21 and the resin frame 5 contract due to temperature change. FIG. 3C shows a state in which the resin grille 21 and the resin frame 5 expand due to temperature change. For the purpose, the resin grille 21 and the resin frame 5 shown in FIG. 3A to 3C are slightly different in dimensions, respectively.

On the outer peripheral edge of the resin frame 5, the engaging claw 5h projecting toward the outside is formed in the circumferential direction, and an inclined surface 5i is formed in the engaging claw 5h. On the other hand, on the outer peripheral edge of the resin grille 21, the hook-like engaging claw 21c that engages with the engaging claw 5h of the resin frame 5 is formed in the circumferential direction. The engaging claw 21c of the resin grille 21 engages with the inclined surface 5i of the resin frame 5 by the elastic force thereof. At this time, the distance in the vertical direction between the line L1 passing through the upper end surface of the resin frame 5 and the line L2 passing through the lower end surface of the resin grille 21 is d5. On the other hand, the distance in the horizontal direction between the line L3 passing through the outer circumferential wall of the resin grille 21 and the line L4 passing through the outer circumferential wall of the resin frame 5 is d6.

When the temperature significantly falls from the state, the resin grille 21 and the resin frame 5 contract in the vertical and horizontal directions. Simultaneously, the vicinities of the engaging claw 21c of the resin grille 21 and the engaging claw 5h of the resin frame 5 contract as below. That is, as shown in FIG. 3B, the vicinity of the engaging claw 21c of the resin grille 21 contracts in the direction of an upward arrow A, and the vicinity of the engaging claw 5h of the resin frame 5 contracts in the direction of a downward arrow B. Further, the vicinities of the engaging claw 21c of the resin grille 21 and the engaging claw 5h of the resin frame 5 also contract in the radial direction (the horizontal direction in the drawing) of the speaker device 100. Accordingly, while the engaging claw 21c and the inclined surface 5i slidingly move relatively, the contact position between the engaging claw 21c of the resin grille 21 and the engaging claw 5h of the resin frame 5 moves upwardly on the inclined surface 5i.

At this time, the distance in the vertical direction between the line L2 passing through the lower end surface of the resin grille 21 and the line L1 passing through the upper end surface of the resin frame 5 changes to d7 (<d5). On the other hand, the distance in the horizontal direction between the line L3 passing through the outer circumferential wall of the resin grille 21 and the line L4 passing through the outer circumferential wall of the resin frame 5 is substantially d6 with little change. This is because the contact position between the engaging claw 21c and the inclined surface 5i moves on the inclined surface 5i by the amounts in which the resin grille 21 and the resin frame 5 contract in the horizontal direction, respectively.

Further, when the temperature significantly rises from the state in FIG. 3A, the resin grille 21 and the resin frame 5 expand in the vertical and horizontal directions. Simultaneously, the vicinities of the engaging claw 21c of the resin grille 21 and the engaging claw 5h of the resin frame 5 expand as below. That is, as shown in FIG. 3C, the vicinity of the engaging claw 21c of the resin grille 21 expands in the direction of the downward arrow B, and the vicinity of the engaging claw 5h of the resin frame 5 expands in the direction of the upward arrow A. Further, the vicinities of the engaging claw 21c of the resin grille 21 and the engaging claw 5h of the resin frame 5 also expand in the radial direction of the speaker device 100. Accordingly, while the engaging claw 21c and the inclined surface 5i slidingly move relatively, the contact position between the engaging claw 21c of the resin grille 21 of and the engaging claw 5h of the resin frame 5 moves downwardly on the inclined surface 5i.

At this time, the distance in the vertical direction between the line L2 passing through the lower end surface of the resin grille 21 and the line L1 passing through the upper end surface of the resin frame 5 changes to d8 (>d5). On the other hand, the distance in the horizontal direction between the line L3 passing through the outer circumferential wall of the resin grille 21 and the line L4 passing through the outer circumferential wall of the resin frame 5 is substantially d6 with little change. This is because the contact position between the engaging claw 21c and the inclined surface 5i moves on the inclined surface 5i by the amounts in which the resin grille 21 and the resin frame 5 expand in the horizontal direction, respectively.

As described above, according to the mounting structure of the resin grille 21 and the resin frame 5 according to the second embodiment, even when the resin grille 21 and the resin frame 5 expand/contract due to temperature changes, the inclined surface 5i of the resin frame 5 and the engaging claw 21c of the resin grille 21 are engaged constantly in an abutting condition. That is, the contact position between the inclined surface 5i of the resin frame 5 and the engaging claw 21c of the resin grille 21 only moves on the inclined surface 5i by the amounts of construction/expansion, and no backlash occurs between the engaging claw 21c of the resin grille 21 and the engaging claw 5h of the resin frame 5. Therefore, in the case where the speaker device 100 is mounted on a ship, even if the vibration from the water surface is transmitted to the engaging claw 5h of the resin frame 5 and the engaging claw 21c of the resin grille 21, no abnormal noise is generated. Thus, the resin frame 5 can be stably mounted on the resin grille 21 independently from the environment changes such as temperature change.

### Third Embodiment

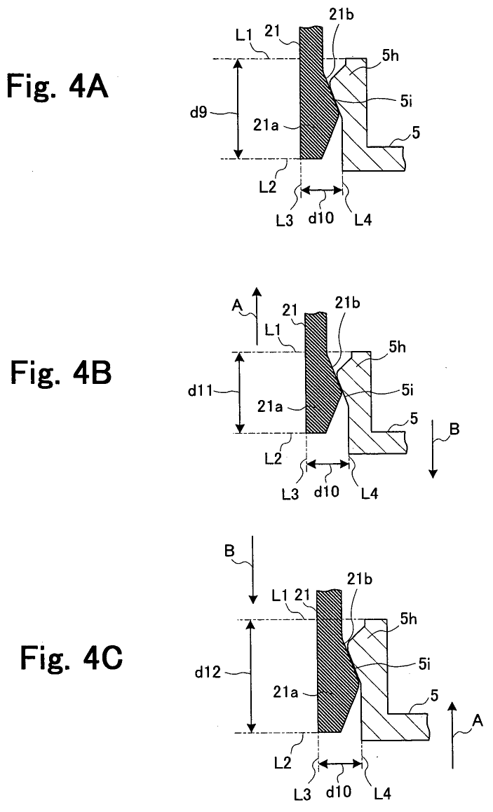

Next, referring to FIGS. 4A to 4C, a mounting structure of the resin frame 5 and the resin grille 21 according to the third embodiment of the invention will be described. In the third embodiment, inclined surfaces are provided in the engaging claw of the resin grille 21 and the engaging claw of the resin frame 5, respectively, and thereby, the same effect in the above first and second embodiments is obtained.

FIG. 4A is a sectional view corresponding to the part of the area E3 in FIG. 1A. FIG. 4B shows a state in which the resin grille 21 and the resin frame 5 contract due to temperature change. FIG. 4C shows a state in which the resin grille 21 and the resin frame 5 expand due to temperature change. For the purpose, the resin grille 21 and the resin frame 5 shown in FIG. 4A to 4C are slightly different in dimensions, respectively.

On the outer peripheral edge of the resin frame 5, the engaging claw 5h projecting toward the outside is formed in the circumferential direction, and the inclined surface 5i is formed in the engaging claw 5h. On the other hand, on the outer peripheral edge of the resin grille 21, the engaging claw 21a that engages with the engaging claw 5h of the resin frame 5 is formed in the circumferential direction and the inclined surface 21b is formed in the engaging claw 21a. The inclined surface 21b of the resin grille 21 and the inclined surface 5i of the resin frame 5 are engaged with each other by the elastic force thereof. At this time, the distance in the vertical direction between the line L1 passing through the upper end surface of the resin frame 5 and the line L2 passing through the lower end surface of the resin grille 21 is d9. On the other hand, the distance in the horizontal direction between the line L3 passing through the outer circumferential wall of the resin grille 21 and the line L4 passing through the outer circumferential wall of the resin frame 5 is d10.

When the temperature significantly falls from the state of FIG. 4A, the resin grille 21 and the resin frame 5 contract in the vertical and horizontal directions. Simultaneously, the vicinities of the engaging claw 21a of the resin grille 21 and the engaging claw 5h of the resin frame 5 contract as below. That is, as shown in FIG. 4B, the vicinity of the engaging claw 21a of the resin grille 21 contracts in the direction of an upward arrow A, and the vicinity of the engaging claw 5h of the resin frame 5 contracts in the direction of a downward arrow B. Further, the vicinities of the engaging claw 21a of the resin grille 21 and the engaging claw 5h of the resin frame 5 also contract in the horizontal direction toward the axial direction of the speaker device 100. Accordingly, while the inclined surface 21b and the inclined surface 5i slidingly move relatively, the contact position between the engaging claw 21c of the resin grille 21 and the engaging claw 5h of the resin frame 5 moves on the inclined surfaces 21b and 5i.

At this time, the distance in the vertical direction between the line L2 passing through the lower end surface of the resin grille 21 and the line L1 passing through the upper end surface of the resin frame 5 changes to d11 (<d9). On the other hand, the distance in the horizontal direction between the line L3 passing through the outer circumferential wall of the resin grille 21 and the line L4 passing through the outer circumferential wall of the resin frame 5 is substantially d10 with little change. This is because the contact position between the inclined surface 21b and the inclined surface 5i moves along the inclined surfaces 5i and 21b by the amounts in which the resin grille 21 and the resin frame 5 contract in the horizontal direction, respectively.

Further, when the temperature significantly rises from the state in FIG. 4A, the resin grille 21 and the resin frame 5 expand in the vertical and horizontal directions. Simultaneously, the vicinities of the engaging claw 21a of the resin grille 21 and the engaging claw 5h of the resin frame 5 expand as below. That is, as shown in FIG. 4C, the vicinity of the engaging claw 21a of the resin grille 21 expands in the direction of the downward arrow B, and the vicinity of the engaging claw 5h of the resin frame 5 expands in the direction of the upward arrow A. Further, the vicinities of the engaging claw 21a of the resin grille 21 and the engaging claw 5h of the resin frame 5 also expand in the horizontal direction opposite to the axial direction of the speaker device 100. Accordingly, while the inclined surface 21b and the inclined surface 5i slidingly move relatively, the contact position between the engaging claw 21c of the resin grille 21 and the engaging claw 5h of the resin frame 5 moves on the inclined surfaces 21b and 5i.

At this time, the distance in the vertical direction between the line L2 passing through the lower end surface of the resin grille 21 and the line L1 passing through the upper end surface of the resin frame 5 changes to d12 (>d9). On the other hand, the distance in the horizontal direction between the line L3 passing through the outer circumferential wall of the resin grille 21 and the line L4 passing through the outer circumferential wall of the resin frame 5 is substantially d9 with little change. This is because the contact position between the inclined surface 21b and the inclined surface 5i moves along the inclined surfaces 5i and 21b by the amounts in which the resin grille 21 and the resin frame 5 expand in the horizontal direction, respectively.

As described above, according to the mounting structure of the resin grille 21 and the resin frame 5 according to the third embodiment, even when the resin grille 21 and the resin frame 5 expand/contract due to temperature changes, the inclined surface 5i of the resin frame 5 and the inclined surface 21b of the resin grille 21 are engaged constantly in an abutting condition. That is, the contact position between the inclined surface 5i of the resin frame 5 and the inclined surface 21bc of the resin grille 21 only moves by the amounts of construction/expansion, and no backlash occurs between the engaging claw 21a of the resin grille 21 and the engaging claw 5h of the resin frame 5. Therefore, in the case where the speaker device 100 is mounted on a ship, even if the vibration from the water surface is transmitted to the engaging claw 5h of the resin frame 5 and the engaging claw 21a of the resin grille 21, no abnormal noise is generated. Thus, the resin frame 5 can be stably mounted on the resin grille 21 independently from the environment changes such as temperature change.

Note that, in the above first to third embodiments, the engaging claws and inclined surfaces formed in the resin frame 5 and/or the resin grille 21 are simultaneously formed with the molding of the main bodies thereof. Thereby, the production cost of the resin frame and the resin grille can be prevented from increasing.

### Fourth Embodiment

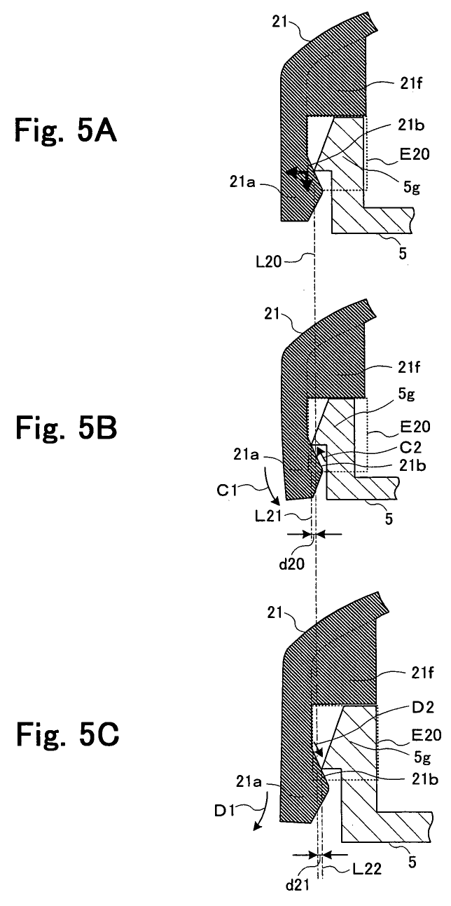

Next, referring to FIGS. 5A to 5C, a mounting structure of the resin frame 5 and the resin grille 21 according to the fourth embodiment of the invention will be described. FIG. 5A is a sectional view in which the part of the area E3 (within the area surrounded by a broken line) in FIG. 1A is enlarged, and the part is slightly different from that of the above speaker device 100. FIG. 5B is a sectional view in a state in which the resin grille 21 and the resin frame 5 contract due to temperature change. FIG. 5C is a sectional view in a state in which the resin grille 21 and the resin frame 5 expand due to temperature change. For the purpose, the resin grille 21 and the resin frame 5 shown in FIG. 5A to 5C are slightly different in dimensions, respectively.

In the speaker device 100, the resin grille 21 is mounted to the resin frame 5 as shown in FIG. 5A. At the inside of the outer peripheral edge of the resin grille 21, the engaging claw 21a projecting toward the central direction is formed in the circumferential direction, and the inclined surface 21b is formed in the engaging claw 21a. Further, in the resin grille 21, a rib 21f having the shape shown in FIG. 5A is formed in a position inside of the outer peripheral edge thereof and facing the upper surface of the engaging claw 5g of the resin frame 5. The rib 21f has a function of blocking the upward movement of the engaging claw 5g of the resin frame 5. Thereby, even when the resin grille 21 and the resin frame 5 expand/contract, the engaging claw 5g of the resin frame 5 can be stably fastened.

On the other hand, at the outside of the outer peripheral edge of the resin frame 5, the hook-like engaging claw 5g that engages with the engaging claw 21a of the resin grille 21 is formed in the circumferential direction. The engaging claw 5g is fit and fastened within an area E20 between the rib 21f and the engaging claw 21a. Further, the inclined surface 21b of the resin grille 21 engages with the engaging claw 5g of the resin frame 5 in a crossed condition as illustrated, and the elastic forces in the vertical and horizontal directions act on the inclined surface 21b of the resin grille 21 and the engaging claw 5g of the resin frame 5 at normal temperature. That is, the engaging claw 21a of the resin grille 21 and the engaging claw 5g of the resin frame 5 are caught in each other and fastened. In this condition, the contact portion (cross portion) of the inclined surface 21b of the resin grille 21 and the engaging claw 5g of the resin frame 5 is located on the line L20 in the section shown in FIGS. 4A to 4C.

When the temperature significantly falls from the state, the resin grille 21 and the resin frame 5 contract. Note that, at this time, vertical dimensions of the resin grille 21 and the resin frame 5 changes little. Thereby, especially, since the vicinity of the engaging claw 21a contracts and curves inwardly as shown by an arrow C1 in FIG. 5B, the engaging claw 5g of the resin frame 5 moves in the direction of an arrow C2 while slidingly moving on the inclined surface 21b. Accordingly, the contact portion (cross portion) between the engaging claw 5g of the resin frame 5 and the engaging claw 21a of the resin grille 21 slightly moves in the outer horizontal direction from the position on the original line L20 by a distance d20. Thereby, the cross portion is located on a line L21.

Further, when the temperature significantly rises from the state in FIG. 5A, the resin grille 21 and the resin frame 5 expand. Note that, at this time, vertical dimensions of the resin grille 21 and the resin frame 5 changes little. Thereby, especially, the vicinity of the engaging claw 21a expands and curves outwardly as shown by an arrow D1 in FIG. 5C, and the engaging claw 5g of the resin frame 5 moves in the direction of an arrow D2 while slidingly moving on the inclined surface 21b. Accordingly, the contact portion (cross portion) of the between the engaging claw 5g of the resin frame 5 and the engaging claw 21a of the resin grille 21 slightly moves in the inner horizontal direction from the position on the original line L20 by a distance d21. Thereby, the cross portion is located on a line L22.

As described above, according to the mounting structure of the resin grille 21 and the resin frame 5 according to the fourth embodiment, even when the resin grille 21 and the resin frame 5 expand/contract or dimensions thereof change in the horizontal direction due to temperature changes, the inclined surface 5i of the resin frame 5 and the inclined surface 21b of the resin grille 21 are engaged constantly in an abutting condition. Accordingly, the contact portion (cross portion) of the inclined surface 21b of the resin grille 21 and the resin frame 5 can absorb the dimension changes of both of them. In other words, the contact portion (cross portion) of the inclined surface 21b of the resin grille 21 and the engaging claw 5g of the resin frame 5 only moves along the inclined surface 21b of the resin grille 21, and no backlash occurs between the engaging claw 21a of the resin grille 21 and the engaging claw 5g of the resin frame 5 and both of them never depart. Therefore, in the case where the speaker device 100 is mounted on a ship, even if the vibration from the water surface is transmitted to the engaging claw 21a of the resin frame 5 and the engaging claw 5g of the resin grille 21, no abnormal noise is generated. Thus, the resin frame 5 can be stably mounted on the resin grille 21 independently from the environment changes such as temperature change.

### MODIFIED EXAMPLE

In the above fourth embodiment, the inclined surface 21b is provided at the engaging claw 21a side of the resin grille 21. However, not limited to that, the same effect as in the above fourth embodiment is obtained by modifying the fourth embodiment of the invention by providing an inclined surface at the engaging claw side of the resin frame 5 as well as in the above second embodiment, or providing inclined surfaces in the engaging claw 21a of the resin grille 21 and the engaging claw 5g of the resin frame 5, respectively, as well as in the above fourth embodiment.

Incidentally, the invention can be also applied to an on-vehicle speaker device. In the case of a speaker device provided within a vehicle, such backlash between the engaging claws becomes more significant due to temperature changes within the vehicle in the summer and winter. Additionally, in the case where the vehicle is traveling, the vibration from the road surface is transmitted to those engaging claws via the speaker device, and sometimes abnormal noise is generated due to rubbing between the engaging claws. According to the invention, in the case where the speaker device is mounted in the vehicle, even when the vibration from the road surface is transmitted to the respective engaging claws of the resin frame 5 and the resin grille 21, no abnormal noise is generated.

1. A resin frame for a speaker device, comprising an engaging claw that engages with an engaging claw of a resin grille, wherein an inclined surface is formed on the engaging claw at a side facing the resin grille.

2. A resin grille for a speaker device, comprising an engaging claw that engages with an engaging claw of a resin frame, wherein an inclined surface is formed on the engaging claw at a side facing the resin frame.

3. The resin grille for a speaker device according to claim 2, wherein a rib for fixing the engaging claw is formed at a side facing an upper surface of the engaging claw of the resin frame.

4. A speaker device comprising:
a resin grille in which an engaging claw is formed; and
a resin frame in which an engaging claw is formed,
wherein the resin grille is mounted to the resin frame by engaging the engaging claws of the resin grille and the resin frame with each other, and
wherein an inclined surface is formed on at least one of the respective engaging claws of the resin grille and the resin frame.

5. The speaker device according to claim 4, wherein the other of the engaging claws of the resin grille and the resin frame has a hook-like shape.

6. The speaker device according to claim 4, wherein the engaging claw of the resin frame is formed on an outer peripheral edge of the resin frame, and wherein the engaging claw of the resin grille is formed on an outer peripheral edge of the resin grille.

7. A speaker device according to claim 4, wherein the resin grille comprises a rib which is formed at a side facing an upper surface of the engaging claw of the resin frame for fastening the engaging claw of the resin frame.
